(19) United States
(12) Patent Application Publication
(10) Pub. No.: US 2009/0025799 A1
(43) Pub. Date: Jan. 29, 2009

(54) Faucet Locking Device

(76) Inventor: Antonio Thor Fraser, Hicksville, NY (US)

Correspondence Address: ANTONIO THOR FRASER, 1714 MONTEREY ROAD, SOUTH PASADENA, CA, 91030, US

(21) Appl. No.: 11/458,688

(22) Filed: Jul. 20, 2006

(51) Int. Cl. F16L 5/00

(52) U.S. Cl. 137/360

(57) ABSTRACT

This patent describes a locking device for securing a standard hose bib faucet. The current implementation consists of two manufactured interlocking pieces of hardened metal that wrap completely around a faucet in clamshell fashion. Once affixed, a person can then attach a lock, such as a standard padlock, to secure the device. Once the device is in place and locked shut, the device completely prevents unauthorized access the faucet, which among other things prevents significant amounts of wanted water. Because the device also wraps around the connector between the hose and the faucet, theft of an attached hose is only possible by completely cutting the hose below the extrusion from the device, thereby deterring theft. Specific device coatings can be used to protect the outside of the device from the elements or chemical manipulation to add to the protection factor.

### FIELD OF THE INVENTION

The invention relates to field of water conservation and misappropriated use of commercial or residential accessible outdoor faucets. The invention prevents all unauthorized individuals from utilizing the water supply when the faucet has the invention installed.

### DETAILED DESCRIPTION OF THE PREFERRED EMBODIMENTS

In preferred embodiments, the device is metal cast into two pieces and engineered to wrap completely around a faucet. Metal is the preferred material of construction, but other tamper resistant materials such as fiberglass or carbon fiber could also be used. The strength of the cast metal and the shape of the two sides provide protection from unauthorized access using standard tools including hammers, crowbars, screwdrivers and pliers. Preferred embodiments of the invention are also reasonably immune to weather due to either a powder or epoxy coating affixed to the outside of the device.

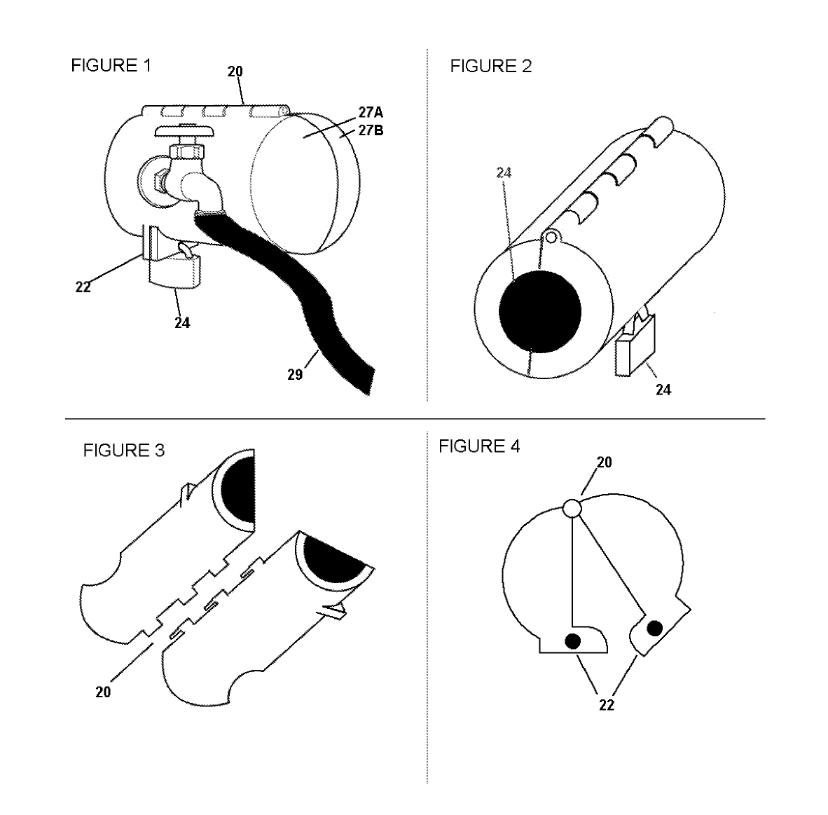

FIG. 1:

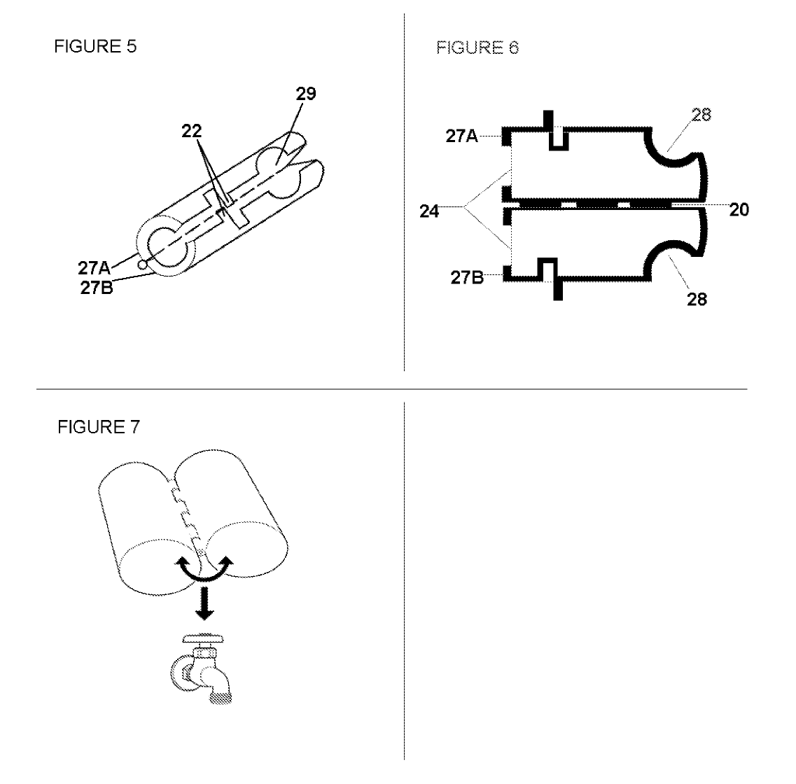

Faucet locking device attached to a faucet. This diagram shows the device left side (27A) and right side (27B) completely closed with the lock (24) attached around a hose bib faucet connected to a pipe hypothetically protruding from an outdoor wall. The diagram also shows the attachment of a garden hose to the faucet with the hose going through the Hose Hole feature (29), which is better depicted in FIG. 5.

FIG. 2:

Faucet locking device from the faucet mount side in the closed position. The diagram shows the device completely filled with high-density foam (24).

FIG. 3:

The fixed pin assembly. This assembly is cast in such a way the Left Side (27A) and Right Side (27B) can fit together like a hinge. The Right Side (27B) has the female end of the fixed pin assembly, while the Left Side (27A) has the male ends of the fixed pin assembly. Though a fixed pin assembly would reduce the cost of manufacturing, it should be stated that a standard hinge welded, glued or otherwise affixed to the device would suffice with the same results.

FIG. 4:

Figure four shows the how the Lock Loops (22) fit together as the Hinge Assembly (20) approaches the closed position. When the device is completely closed, the Lock Loops (22) line up so a padlock (24) can fit through them. In preferred embodiments the Lock Loops (22) run perpendicular to the device. This design allows recession of the Lock Loop on either side (27A and 27B) into the other side (27B and 27A). This recessed Lock Loop design property permits the open exposure of the Lock Loop holes while substantially reducing the surface area of the metal surrounding them, thereby reducing the risk of someone cutting off the Lock Loops hacksaw or prying them off with a crowbar.

The device could be constructed in such a way that the Lock Loop holes extend from the device and run parallel much the same way a lady's purse has handles running in parallel and extruding from the purse. But this purse type design would easily give way to someone sticking a crowbar between the lock and device and popping the Lock Loops free.

Preferred embodiments show the lock loops on the opposite side of the hinge assembly. Quality control after manufacturing and design testing will dictate if this is in fact the preferred design of this device. It is just as likely the device won't be an exact clamshell, more like a smaller clamshell top and a larger clamshell bottom. Complete encasement is a property of this invention, but exact symmetry between the two encompassing sides is not.

Figure Five:

Figure five shows the lock loops (22) recessing into the device. In preferred embodiments, the hinge pin assembly would require the lock loops to be constructed the opposite way of the hinge pin assembly to prevent forward and backward shift when the device was in a closed position.

Figure Six:

Figure six depicts the inside of both sides of the device (27A and 27B). Both sides are filled with a commercial grade High Density Foam (24). The foam's main purpose is to give the unit a produce fit and hold the device in position. The displacement of the foam when compressed around the faucet will nearly lock the faucet into place. High Density Foam (24) is one of the most durable weather resistant foams on the market today, allowing the device to be affixed to another faucet if the device owner chooses move it elsewhere. In preferred embodiments, High Density Foam will be used for a filler material because it can return to it's original state over time, though any foam like substance such as Styrofoam could be used to fill the device.

### BACKGROUND OF THE INVENTION

As facilities have outdoor faucets installed, whether on public or private property, historically those faucets have been subject to all sorts of unauthorized usage. For example, one food service company manager noted bars of soap next to his outdoor faucet, as it was a constant showering station by the local vagrants. Also, a public official noted constant nightly usage of the faucet causing flooding in flowerbeds. A store owner once told me that a standard pressure outdoor faucet an unauthorized user left on for a 24 hour period wasted over 10,000 gallons of water, roughly equivalent to the water volume required to fill a standard back yard swimming pool.

The companies and facilities I am in contact with, when combined, are paying for millions of gallons worth of unauthorized water usage under these and similar circumstances. Living in a desert environment where water is commonly rationed, these problems are extremely real for those I am in contact with, both legally and financially. After some research on residential and commercial housing codes nationwide, even if not in the desert, this unauthorized usage of water is most likely costing us, as a country, billions of gallons of wasted water consumption.

As a person familiar to the problems of building maintenance, business owners and public officials have often come to me asking me to solve this problem. There are few products and practices available to mitigate this problem. The first is simply removing the faucet handle. Anybody with a pair of pliers can open a faucet with the handle removed. The second common technique is installing a locking faucet that requires a key to open. This too can be opened simply with a pair of needle nosed pliers. After trying both of these two techniques on several occasions in several environments and still without success in securing these faucets, we came up with the concept of a device that wraps completely around the faucet, from the base, over the handle, to the very end of the faucet opening, completely covering any attached hose if a hose is attached. The device fits securely, is reasonably immune to standard tool manipulation, and upon installation, allows the faucet to be protected and secured with a standard padlock or similar locking device.

In the preferred embodiments of this invention, the only way to open the device would be with either a metal cutting torch or a metal cutting hacksaw. If an individual did attempt to obtain access to the faucet with a hacksaw, it would take more than an hour to disassemble the device. In either of these cases, this unauthorized user is most likely a reasonably skilled and person with capital to purchase appropriate tools, not the type of person the invention was designed to prevent access to.

1. Faucet with attached locking device prevents unauthorized faucet utilization and unauthorized water usage by completely encapsulating the faucet in tamper resistant material such as forged steel, carbon fiber, or aluminum.

2. Faucet with attached locking device prevents tampering or theft of an attached hose if a hose is attached.

3. Faucet with attached locking device requires no additional pieces to initiate protection other than a simple lock such as a standard padlock when locking the device externally, or a forged mounted tumbler when locking the device internally.

4. Locking device can be installed around faucet without any specialized tools.

5. Faucet with attached locking device is reasonably immune to standard tool manipulation and vandalism.

6. Faucet with attached locking device completely prevents people from viewing the faucet type.

7. Faucet with attached locking device will add significant physical protection to faucet from non-intentional mishaps such as bumping a faucet with a car, hitting faucet with a lawn tractor, etc.
